(19) United States
(12) Patent Application Publication
(10) Pub. No.: US 2013/0204474 A1
(43) Pub. Date: Aug. 8, 2013

(54) RECHARGEABLE BATTERY PACKAGES

(71) Applicants: Lazlo Gyenes, Crowthorne (GB); Michael Cordell, Birmingham (GB); James Sore, Stratford-upon-Avon (GB); Tom Wood, Stratford-upon-Avon (GB)

(72) Inventors: Lazlo Gyenes, Crowthorne (GB); Michael Cordell, Birmingham (GB); James Sore, Stratford-upon-Avon (GB); Tom Wood, Stratford-upon-Avon (GB)

(21) Appl. No.: 13/695,320

(22) PCT Filed: May 3, 2011
(86) PCT No.: PCT/GB11/50864

§ 371 Date: Dec. 22, 2012

(30) Foreign Application Priority Data
Apr. 30, 2010 (GB) 1007246.0

(51) Int. Cl. H01M 10/48; B60L 11/18

(52) U.S. Cl. CPC H01M 10/48; B60L 11/1824
USPC 701/22; 429/91; 320/109

(57) ABSTRACT

An electric vehicle (4) with a rechargeable battery package (5) and a recharging system (1) for recharging the package (5). The package 5 has a plurality of rechargeable cells (50) and an integrated RFID tag (51) that is powered by an independent lithium-ion battery and has first and second memory areas. The first memory area is configured to permanently store identification data specific to the unique identity of the package (5). The second memory area is arranged to accumulate and store data relating to charge and discharge profiles for the package (5), operational conditions reflecting use of the package (5) during at least a portion of its lifetime, an event log recording operation of the package (5) outside of its recommended use parameters, energy status information for the cells (50) and/or event data pertaining to times of disconnection of the package (5) from an electrical circuit. The recharging system (1) also includes a refuelling station (2) that includes a fuel management terminal (3) and a lead (20) for connecting the vehicle (4) to a source (21). The system 1 also incorporates a security algorithm that is configured upon connection of the vehicle (4) to the refuelling station (2) to disable the vehicle (4) and to prevent or inhibit unauthorised disconnection of the lead (20).

This invention relates to the control and monitoring of battery management. This invention is particularly, but not exclusively, concerned with the use of shielded radio frequency identification (RFID) tags in electric vehicles, such as cars, to record battery usage and charge states. This invention is also concerned with systems for preventing unauthorised and/or accidental removal of a refuelling connection, especially in electric vehicles. Aspects of the present invention relate to networked systems that interact with multiple, uniquely identifiable rechargeable battery packages.

Environmentally conscious societies are aware that conventional combustion engines produce greenhouse gas emissions. To reduce such emissions, governments are encouraging people to make less use of cars. At the same time car companies are developing other forms of drive mechanism, including hydrogen fuel-cells and battery-powered vehicles or petrol-battery hybrids. There is nevertheless a carbon footprint associated with storing the electrical energy in the battery in the first place, although this is relative low compared with hybrid or full petrol/diesel engines.

Battery-powered electric vehicles (EVs) are currently available, such as the G-Wiz, although range and power are presently limited as a consequence of both a realistic power to weight ratio (given the weight of current battery technologies) and the availability of re-charge facilities. Currently, conventional battery-driven passenger vehicles, such as a family car, have a limited range and often require a re-charge after about 100 miles or so. Whilst there have been some developments in this area, for instance the Tesla Roadster can allegedly travel up to 220 miles on a single charge, frequent recharging is and will continue to be an issue that must be addressed before EVs become viable for mass use.

Batteries store electricity in a chemical form inside a closed-energy system. In EV applications, the batteries are also subjected to moderately harsh environments, including potentially high degrees of vibration, shock, heat variations and sulfation of their lead plates. This means that few automotive batteries last beyond six years of regular use, and sometimes considerably less (especially when mistreated).

Automotive applications have historically made use of lead-acid rechargeable batteries since there are inexpensive, but this is offset by their main drawbacks, namely that they are physically large in size and weight for a given capacity and voltage. With lead-acid batteries, care must be exercised to avoid deep discharging, since each charge and discharge cycle causes active material to be shed from its internal plates. More particularly, it is understood that lead-acid batteries should never be discharged to below 20% of their full capacity, because internal resistance will cause heat and damage when they are recharged.

To this effect, “Deep-cycle” lead-acid batteries (such as those used in EVs) have much thicker plates to aid their longevity. Deep-cycle lead-acid systems often use a low-charge warning light or a low-charge power cut-off switch to prevent the type of damage that will shorten the battery's life.

New automotive battery technologies are however being developed, e.g. lithium-ion (Li-ion) battery technology. Such lithium-ion batteries are able to deliver high currents, but can discharge very rapidly when short-circuited. Li-ion batteries are, however, relatively expensive. Unfortunately, a too-rapid discharge of a lithium battery can result in overheating of the battery, rupture and even explosion.

Some form of battery management is therefore required to monitor battery treatment.

According to a first aspect of the present invention there is provided a rechargeable battery package comprising: a) at least one rechargeable cell for storing energy; and b) an interactive storage device preferably in the form of a radio frequency identification tag, e.g. an active RFID tag, the interactive storage device is preferably integrated into the package and more preferably configured to derive power for its operation independently of energy stored by the at least one rechargeable cell, the interactive storage device including: a first memory area configured to permanently store identification data specific to a unique identity of the rechargeable battery package; and a second memory area arranged to accumulate and store at least one of: i) charge and discharge profiles for the rechargeable battery package; ii) operational conditions reflecting use of the package during at least a portion of the lifetime of the rechargeable battery package; iii) an event log recording operation of the rechargeable battery package outside of recommended use parameters for the specific rechargeable battery package; iv) energy status information for the at least one cell; and v) event data pertaining to times of disconnection of the rechargeable battery package from an electrical circuit.

Advantageously, preferred embodiments of the present invention therefore support an active RFID tag that contains an independent power supply (such as a battery, e.g. a Li-ion battery) to permit recordal and storage of data. More particularly, the interactive storage device may be configured for interaction with the on-board power management system of an electric vehicle and/or for direct monitoring of battery state conditions, e.g. thereby to allow the interactive storage device to record charge and discharge rates against battery identity. The stored data in the interactive storage device may be configured to provide an historical record of treatment. The record can be used, e.g., to identify faulty batteries, or otherwise to deny a warranty claim if it can be established that the battery has been inappropriately subjected to misuse outside of the manufacturer's reasonable operating parameters.

In a second aspect of the present invention there is provided an electric vehicle comprising a rechargeable battery package as described above.

A third aspect of the invention provides a terminal, e.g. a physically remote terminal, configured to interact with the interactive storage device of the rechargeable battery package, which terminal may include a processor arranged to retrieve and assess data stored in both the first and second memory areas.

The processor may be further arranged to reconcile the amount of charge delivered to the cells of the rechargeable battery package at the terminal relative to the state of the cells at the time of arrival of the battery package at that terminal.

The terminal may be located at a recharging station or centre for the rechargeable battery package.

Advantageously, the processor may be wirelessly connectable to the interactive storage device. Further, the processor may be arranged or configured to provide the data acquired from the interactive storage device to an accounting sub-system (which may be a point-of-sale device directly associated with the terminal) that permits generation of a financial account statement or settlement demand reflecting the recorded use or determined state of the rechargeable battery package as ascertained at the terminal.

The data downloaded to the terminal from the interactive storage device (either upon request or automatically) may reflect contiguous visits of the EV (and thus the rechargeable battery package) to one or more terminals over an extended period of time, or may simply reflect the recorded variations in battery usage from the last time that the interactive storage device interfaced with a terminal to download recorded battery management related data.

A fourth aspect of the invention provides a recharging station or centre for recharging an electric vehicle as described above, which centre may comprise at least one terminal as described above.

A fifth aspect of the invention provides an electric vehicle recharging system comprising one or more of a rechargeable battery package and/or an electric vehicle and/or a terminal and/or a recharging station or centre as described above.

The battery package and/or electric vehicle and/or terminal and/or recharging station or centre and/or system may be configured to prevent unauthorised and/or accidental removal of a refuelling or recharging connection. For example, the battery package and/or vehicle may be configured to be disabled or non-operational when it is connected to or interacting with the terminal and/or recharging station or centre and/or a fuel source.

Further aspects of the invention provide one or more of a battery package and/or electric vehicle and/or terminal and/or recharging station or centre and/or system configured to prevent unauthorised and/or accidental removal of a refuelling connection. The battery package and/or vehicle may be configured to be disabled or non-operational when it is connected to or interacting with the recharging station or centre or a fuel source. Additionally or alternatively, the recharging station or centre may be configured to disable or prevent operation of the battery package and/or vehicle when it is connected thereto or interacting therewith.

A more general aspect of the invention provides a security system for a vehicle refuelling connection, the system comprising a refuelling station, a vehicle and a connection means for operatively connecting the station to the vehicle, wherein the system is configured upon connection of the station to the vehicle to disable the vehicle or its drive system and/or render the vehicle inoperative and/or prevent movement of the vehicle relative to the refuelling station and/or prevent or inhibit disconnection, e.g. unauthorised disconnection, of the connection means.

In some embodiments, the connection means comprises a connector or plug or nozzle operatively connected to one of the station and vehicle, e.g. for cooperating with a corresponding connector or plug or receptacle in the other of the station and vehicle, one or each of which may comprise a locking means or system or mechanism, for example to prevent disconnection, e.g. mechanical disconnection that may be unauthorised.

Additionally or alternatively, the connection means may be configured to interact with or operate an immobilizer of the vehicle, for example the or an anti-theft immobilizer of the vehicle.

Unauthorised disconnection may, for example, include one or more of the following circumstances: theft, failed payment and/or attempted departure while the vehicle is still connected to the station.

Further aspects of the invention provide a computer program element comprising computer readable program code means for causing a processor to execute a procedure to control or implement the system described above, which element or code means may be embodied on a computer readable medium and/or incorporated or programmed into a computer and/or vehicle and/or terminal and/or refuelling or recharging station or centre and/or system as described above.

A yet further aspect of the invention provides a retrofit kit for adapting a vehicle and/or terminal and/or recharging station or centre or system, the kit comprising the program element or computer readable medium described above.

Embodiments of the invention will now be described by way of example only with reference to the accompanying drawings in which:

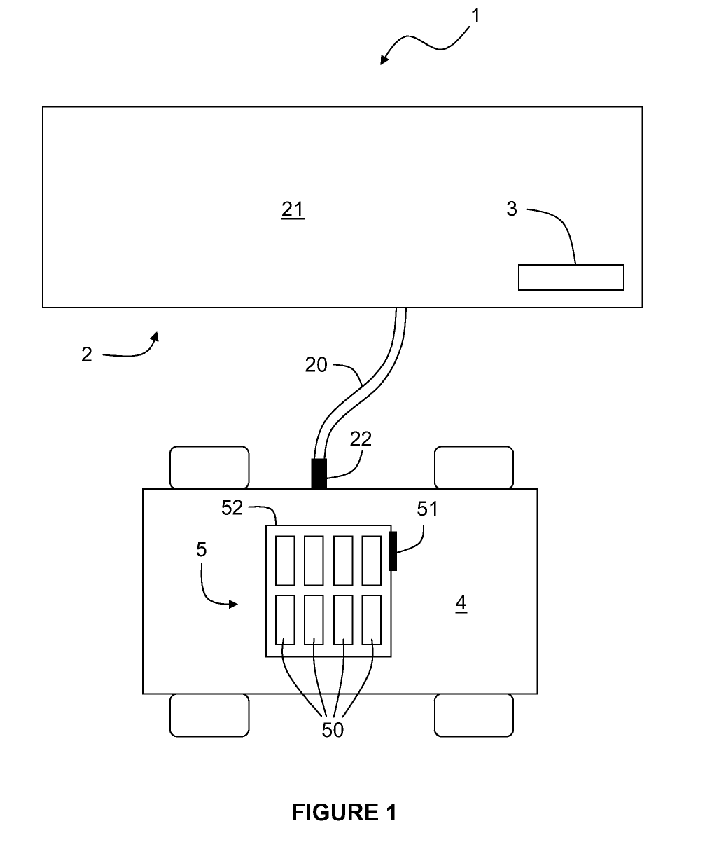

FIG. 1 is a schematic of a vehicle refuelling system according to one embodiment of the invention; and

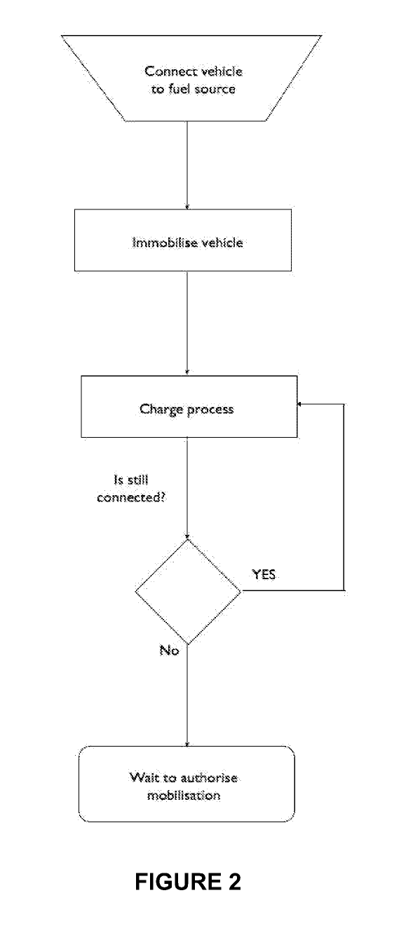

FIG. 2 is a flow chart illustrating the function of a security system for a refuelling connection according to the invention.

Preferred embodiments of the invention can be selectively combined, as appropriate, to produce rechargeable battery packages having differing degrees of functionality. FIG. 1 shows a refuelling system 1 that includes a refuelling station 2 with a fuel management terminal 3 and an electric vehicle (EV) 4 with a battery package 5. The system 1 incorporates a security system as shown in FIG. 2.

The refuelling station 2 includes a filling hose or lead 20 connected at one of its ends to an electrical fuel source 21 and having a plug or nozzle 22 at its opposite end for connection to the EV 4. The fuel management terminal 3 is also incorporated into the refuelling station 2 in this embodiment.

The battery package 5 includes a plurality of rechargeable cells 50 and an active RFID tag (or the like) 51 integrated into the body 52 of the battery package 5. The active tag 51 is generally insulated and designed to operate in close proximity to a metal surface in an engine compartment of the EV 4.

The tag 51 includes two areas of non-volatile memory. A first area of memory is designated to hold permanent tracking data relating to the battery package 5 and is programmed and locked at the time that the battery package 5 is manufactured. The data will typically include, for example, the date of manufacture, a serial number, product type and manufacturer, although certain application may simply require a uniquely identifiable serial number (with related information located elsewhere). A second area of memory is designated to record and store information on the usage and charging of the battery package 5 and/or one or each or all of the rechargeable cells 50. This will typically include the number times the battery package 5 and/or cells 50 has been re-charged, whether the battery package 5 and/or cells 50 has been charged using the domestic mains, details of misuse (e.g. taking the battery package 5 and/or cells 50 below the recommended minimum charge level) and rates of discharge and the like.

Preferably, the tag 51 will be self powered with a life of at least 5 years. Preferably, the tag 51 will not use the battery package 5 and/or cells 50 as its power source, but rather will be internally powered. In the event of the battery package 5 and/or one or more cells 50 failing, the tag 51 will still be able to provide all the relevant information about the unit since the tag 51 operates on a state-machine basis in that it permanently records critical events as they occur and permits recovery of that data at a later date.

The tag 51 will communicate with the on board power management system of the EV 4 and is arranged to record the level of usage. Events that will be recorded on the tag 51 will typically include: i) re-charging the battery package 5 (or the cells 50 thereof) from the domestic mains; ii) details relating to the present level of charge; iii) times and values when the battery package 5 and/or cells 50 are subjected to discharge below recommended levels; iv) times of removal of the battery package 5 and/or cells 50 from the EV 4 when the EV 4 is not at an accredited replacement site, with this event triggered (for example) by the disconnection of the battery package 5 from the power management system of the EV 4 and at a point when no communication to the tag 51 is detected.

In terms of an overall network, data acquired by the power management system of the EV 4 and/or direct from the tag battery (not shown) is selectively transmitted to the terminal 3 at the time that the battery package 5 is being charged or exchanged/changed. Data stored in the tag 51 can therefore be used to establish the financial amount that the customer would be required to pay to compensate for the nature and/or use of the rechargeable battery package 5 at the point of charging or exchange at an accredited dealership.

The dealership may be networked into a centralised database to allow for a complete history to be downloaded and thus accumulated for each specific battery package 5, although the nature of the tag 51 may simply continuously store and history locally with its associated battery 5 or cells 50 to allow periodic download on a requested to automatic basis.

From an implementation perspective, the functional aspects of storage and interrogation of rechargeable battery package 5 data is generally implemented using software.

When a battery package 5 arrives at an exchange or recharging station 2, e.g. when the EV 4 drives into a garage or service station (not shown), the tag 51 is read by a terminal 3. The terminal 3 operates to establish the identity of the battery package 5 (from the permanently stored record in the first memory area of the tag 51) together with a current state of charge of the rechargeable battery package 5 and/or cells 50. The terminal 3 also looks for any misuse or charging events that had occurred outside operating parameters set by the manufacturer of the battery package 5.

The terminal 3 preferably then calculates an invoice amount that would be payable by the customer, or otherwise communicates the recovered data (over a WAN or LAN) to a server (not shown) that cooperates with a centralised accounting system (not shown) located remotely from the terminal 3 and refuelling station 2.

If rechargeable battery packages 5 and/or cells 50 being recharged or exchanged have, say, 25% charge left, then this will be credited against the cost of the full charge in the replacement battery package 5 and/or cells 50.

Where the battery package 5 and/or cells 50 have been recharged using the domestic mains (where the rate or nature of a charging regime is sub-optimal and may impair battery life), a service charge may be levied to reflect the effective reduction in the life of the battery package 5 and/or cells 50. If there has been a misuse of the battery package 5 and/or cells 50 that reduces the operational life of the battery package 5 and/or cells 50, a charge to reflect this cost may also be levied by the accounting system.

In is envisioned that the system 1 will operate either through a payment kiosk (not shown), similar to that at a conventional service station, or by inserting a credit/debit card or cash into a suitable reader (not shown) mounted at the refuelling station 2 at the battery exchange or recharging facility. Equally, the vehicle may also carry an RFID tag (not shown) which would link it to an account facility.

Software at the terminal 3 is further arranged to manage the charging process in the event that the rechargeable battery package 5 and/or cells 50 is/are coupled directly to a charging device through an appropriate umbilical hose or lead 20.

From a management perspective at the facility, any exchanged battery packages 5 and/or cells 50 may be treated on the basis of relative stored charge. Therefore, relatively highly partially charged battery packages 5 and/or cells 50 will be charged over deeply discharged battery packages 5 and/or cells 50 to ensure that fully charged battery packages 5 and/or cells 50 are always available at the facility. In the event of excess demand, the facility operates to supply partly charged battery packages 5 and/or cells 50 and the price accordingly adjusted to reflect the actual level of usage. The interactive memory device 51 therefore provides a critical data in tracking and following the usage of specific rechargeable battery packages 5 and/or cells 50.

Defective battery packages 5 and/or cells 50 will be identified by the system 1 and quarantined, e.g. based on retained charge or rates of energy dissipation when the battery package 5 and/or cells 50 is/are in a known, stable condition. Software executed by a controller or processor in the terminal 3 is therefore able, if desired, to report any faulty battery packages 5 and/or cells 50 to a central back office (not shown), which can organise a replacement battery package 5 and/or cells 50 and collection of the defective battery packages 5 and/or cells 50.

Where the failure is within the warranty period of the battery package 5 and/or cells 50, the terminal 3 will automatically generate a claim against the manufacturer whose details will be determined from the serial number on the RFID tag 51. If the use has been inappropriate, then the warranty may be invalidated based on the downloaded record of use.

It will, of course, be appreciated that the above description has been given by way of example only and that modification in detail may be made within the scope of the present invention. For example, whilst a preferred embodiment refers to the use of the rechargeable battery package 5 in the context of EVs 4, the rechargeable battery package 5 has wider application in other technologies requiring monitoring of rechargeable batteries, for example where such batteries are used to power a refrigeration unit or the like, e.g. the refrigeration unit on a refrigeration lorry.

Also, unless the context requires specific use of radio spectrum communications, the term RFID should be considered to encompass other forms of local storage device, including static memory that is accessed through a physical connection. For example, non-volatile RAM can be used to store and recover battery condition and battery identity data, although wireless connectivity is preferred since this allows for easier communication with remote systems, such as commercially provided recharge terminals configured to exchange data with the RFID tag 51 in the battery package 5.

Wireless connectivity can be achieved through a variety of known technique appreciated by the skilled addressee, including Bluetooth. Wireless connectivity is also preferably only active over a short range, thus ensuring that only a single battery package is engaged or interrogated in an in situ state. A detailed discussion of such readily known communication techniques (that permit data to be exchanged, sent or recovered from the storage device integrated into the battery package 5) is therefore not germane to the principles underlying the present invention, since this the communication protocols are design options.

Of course, both wireless and direct physical connections may be provided on the same rechargeable battery package 5 to support connectivity, but this is merely a design option of a preferred embodiment.

While a preferred embodiment refers to “rechargeable” battery packages 5 and/or cells 50 in the sense that they are charged in situ within the EV 4, the skilled person will also appreciate that the principle can be extended to batteries that are easily substitutable/replaceable. By way of limited explanation, a driver of a vehicle 2 might simply be prepared to exchange one battery package 5 and/or cells 50 for another, rather than to wait for a currently installed battery package 5 and/or cells 50 within the EV 4 to be recharged. In this way, the tagging system allows for tracking and invoicing of replacement battery packages 5 and/or cells 50 through a centralised computer network (and associated database) that tracks and records the unique identity of the battery package 5 and/or cells 50 and battery condition or usage data acquired during charge and discharge of a specific battery package 5 and/or cells 50 when installed in an EV 4.

The terms “package”, “unit” and “pack” are interchangeable and reflect the fact that battery cells are provided in a suitable housing that incorporates an interactive, non-volatile storage device that is operational to record, in real time, event data specific to the overall assembly. The terminology should therefore be broadly construed, unless the specific context of a particular embodiment requires a specific interpretation.

It will be appreciated by those skilled in the art that any number of combinations of the aforementioned features and/or those shown in the appended drawings provide clear advantages over the prior art and are therefore within the scope of the invention described herein.

1. A rechargeable battery package comprising:
a) at least one rechargeable cell for storing energy; and
b) an interactive storage device integrated into the package and configured to derive power for its operation independently of energy stored by the at least one rechargeable cell, the interactive storage device including:
a first memory area configured to permanently store identification data specific to a unique identity of the rechargeable battery package; and
a second memory area arranged to accumulate and store at least one of:
i. charge and discharge profiles for the rechargeable battery package;
ii. operational conditions reflecting use of the package during at least a portion of the lifetime of the rechargeable battery package;
iii. an event log recording operation of the rechargeable battery package outside of recommended use parameters for the specific rechargeable battery package;
iv. energy status information for the at least one cell; and
v. event data pertaining to times of disconnection of the rechargeable battery package from an electrical circuit.

2. Package according to claim 1, wherein he interactive storage device comprises a radio frequency identification tag.

3. Package according to claim 1, wherein the interactive storage device comprises an active radio frequency identification tag.

4. Package according to claim 1, wherein the interactive storage device comprises an independent power supply,

5. Package according to claim 4, wherein the independent power supply comprises a lithium-ion battery.

6. Package according to claim 1, wherein the interactive storage device adapted for connection and/or interaction with the on board power management system of an electric vehicle.

7. An electric vehicle comprising an on-board power management system and a package according to claim 1, wherein the interactive storage device is operatively connected to the on-board power management system for interaction therewith.

8. A terminal configured to interact with the interactive storage device of the rechargeable battery package of claim 1, the terminal including a processor arranged to retrieve and assess data stored in both the first and second memory areas,

9. Terminal according to claim 8, wherein the processor is further arranged to reconcile the amount of charge delivered to the cells of the rechargeable battery package at the terminal relative to the state of the cells at the time of arrival of the battery package at that terminal.

10. Terminal according to claim 8, wherein the processor is wirelessly connectable to the interactive storage device.

11. Terminal according to claim 8, wherein the processor is further arranged or configured to provide the data acquired from the interactive storage device to an accounting sub-system that permits generation of a financial account statement or settlement demand reflecting the recorded use or determined state of the rechargeable battery package as ascertained at the terminal.

12. Terminal according to claim 11, wherein the accounting sub-system comprises a point-of-sale device directly associated with the terminal.

13. A recharging station or center for recharging an electric vehicle according to claim 7, the station or center comprising at least one terminal according to claim 8.

14. A recharging station or center for recharging an electric vehicle according to claim 7, the station or center comprising at least one terminal according to claim 11 and further comprising an accounting sub-system.

15. A recharging station or center as claimed in claim 13 further comprising a connection means for connecting the battery package to the station or center to a source of fuel, wherein the station or center is configured upon connection of the battery package to disable the battery package or a vehicle in which it is comprised and/or to inhibit disconnection of the connection means.

16. An electric vehicle recharging system comprising two or more recharging centers according to claim 13.

17. A security system for a vehicle refuelling connection, the system comprising a refuelling station, a vehicle and a connection means for operatively connecting the refuelling station to the vehicle, wherein the system is configured upon connection of the vehicle to the refuelling station to disable the vehicle or its drive system and/or to prevent or inhibit unauthorised disconnection of the connection means.
